(19) United States
(12) Patent Application Publication
(10) Pub. No.: US 2008/0052612 A1
(43) Pub. Date: Feb. 28, 2008

(54) System for creating summary clip and method of creating summary clip using the same

(75) Inventors: Doo Sun Hwang, Seoul (KR); Ki Wan Eom, Suwon-si (KR); Ji Yeun Kim, Seoul (KR); Sang Kyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/889,664

(22) Filed: Aug. 15, 2007

(30) Foreign Application Priority Data
Aug. 23, 2006 (KR) 10-2006-0079788

(51) Int. Cl. G06F 15/00

(52) U.S. Cl. 715/201

(57) ABSTRACT

A summary clip generation system according to the present invention includes: an event detection unit detecting a video event and an audio event from multimedia contents; a segment generation unit generating at least one segment by dividing or merging at least one shot which forms the multimedia contents, by referring to the video event; and a segment selection unit selecting a segment whose uprush degree is greater than a predetermined level, from the at least one segment by referring to the uprush degree which is calculated using the video event and the audio event, corresponding to each of the generated segments.

### CROSS-REFERENCE TO RELATED APPLICATION

This application claims the benefit of Korean Patent Application No. 10-2006-0079788, filed on Aug. 23, 2006, in the Korean Intellectual Property Office, the disclosure of which is incorporated herein by reference.

### BACKGROUND OF THE INVENTION

1. Field of the Invention

The present invention relates to a summary clip generation method. More particularly, the present invention relates to a summary clip generation system which can generate a summary clip of multimedia contents using an uprush degree of each segment which is divided or merged in the multimedia contents, and a summary clip generation method using the system.

2. Description of Related Art

Currently, in the information technology (IT) field, various video media are actively provided. Starting with new video services such as satellite Digital Multimedia Broadcasting (DMB), terrestrial DMB, data broadcasting, Internet broadcasting, and in the IT field including communications, Internet services, and digital devices, the video on demand industry continues to expand.

The present “era of portable TV” started with the satellite/terrestrial DMB, and mobile telecom companies then started to extend multimedia on demand service via data broadcasting of their own companies via consortiums with content companies. Also, Internet portal sites provide to users via sites of their own company and cooperation sites, homemade videos or videos secured via the consortiums with the content companies.

In addition, TV portal sites currently provided are predecessors of Internet TV and implement a service in which users can watch movies or dramas provided by the portal sites by downloading or streaming as video on demand (VOD) via a PC, a notebook PC, and a mobile communication terminal. Further, Triple Play Service (TPS), in which the Internet, broadcasting, and telephonic communication are provided together over a single broadband connection is expected to increase, and the demand for video content will increase even more.

As a result of this continuing expansion of video content delivery, younger generations are so familiar with this video culture that video is not an optional feature but an essential feature. In response, industries related to video are seen as the most competitive of all IT fields. Accordingly, a market of video replay terminals such as DMB terminals and Portable Multimedia Players (PMPs) continues to expand.

Mobile telecom companies competitively release satellite DMB phones and terrestrial DMB phones, and MP3 player companies release various models of PMPs supporting DMB. Currently, an MP3 player is also equipped with a minimal LCD as a display unit, whose size is 2 inches, thereby supporting the function of replaying a video. The various video support terminals described need to be developed into convergence products supporting all types of video services in one terminal.

As described above, with development of multimedia services and performance of terminals, the demands of users pursuing convenience are increasing. However, it is difficult to search for desired multimedia and acquire information for the multimedia being searched for in a conventional multimedia service. Accordingly, a request for a multimedia summary clip which can more conveniently acquire information of multimedia moves to the forefront.

Conventionally, various multimedia summary methods have been introduced in order to satisfy users' demands. As an example, a multimedia summary method that sequentially divides multimedia contents to summarize the multimedia contents into a shot, a scene, and a segment has been introduced. However only the shot, the scene and the segment selected by the user can be seen in the method, therefore a summary in a length the user desires can not be provided. Also, as another example, a multimedia summary method which extracts a multimedia summary part using an audio volume in the multimedia content, and generates a highlight as long as the user requires has been introduced, however accuracy for the generated highlight of the multimedia can not be guaranteed since the method generates the highlight only using the audio volume.

Accordingly, a new technique which can calculate an uprush degree for each segment, and generate a summary clip of the multimedia using the calculated uprush degree according to a user's requirements and type of multimedia is provided.

### BRIEF SUMMARY

An aspect of the present invention provides a summary clip generation system and a summary clip generation method which can generate a summary clip of multimedia contents using uprush degree of at least one segment which is calculated by dividing or merging a shot forming the multimedia contents.

An aspect of the present invention also provides a summary clip generation method which can satisfy a user's need since a summary clip is generated by selecting a segment according to a user's requirements or a type of multimedia contents.

An aspect of the present invention also provides a summary clip generation method which can accurately extract a highlight portion since a summary clip of multimedia contents is generated using a shot change rate, an audio signal energy, and a music class ratio.

According to an aspect of the present invention, there is provided a summary clip generation system including: an event detection unit detecting a video event and an audio event from multimedia contents; a segment generation unit generating at least one segment by dividing or merging at least one shot which forms the multimedia contents, by referring to the video event; and a segment selection unit selecting a segment whose uprush degree is greater than a predetermined level, from the at least one segment by referring to the uprush degree which is calculated using the video event and the audio event, corresponding to each of the generated segments.

According to another aspect of the present invention, there is provided a clip generation method including: detecting a video event and an audio event from multimedia contents; generating at least one segment by dividing or merging at least one shot which forms the multimedia contents, by referring to the video event; selecting a segment whose uprush degree is greater than a predetermined level from the at least one segment by referring to the uprush degree which is calculated using the video event and the audio event, corresponding to each of the generated segments; and generating a summary clip by using the selected segment.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram illustrating a configuration of a summary clip generation system according to an exemplary embodiment of the present invention;

FIG. 2A and FIG. 2B are graphs illustrating an example of detecting a video event according to an exemplary embodiment of the present invention;

FIG. 3 is a block diagram illustrating an example of a segment generation unit of FIG. 1;

FIG. 4, parts I through VI are diagrams illustrating examples of detecting a similar shot color information according to an exemplary embodiment of the present invention;

FIG. 5 is a block diagram illustrating an example of a segment selection unit of FIG. 1;

FIG. 6 is a flowchart illustrating a summary clip generation method according to an exemplary embodiment of the present invention;

FIG. 7 is a flowchart illustrating an example of a segment generation method of FIG. 6; and

FIG. 8 is a flowchart illustrating an example of a segment selection method of FIG. 6.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

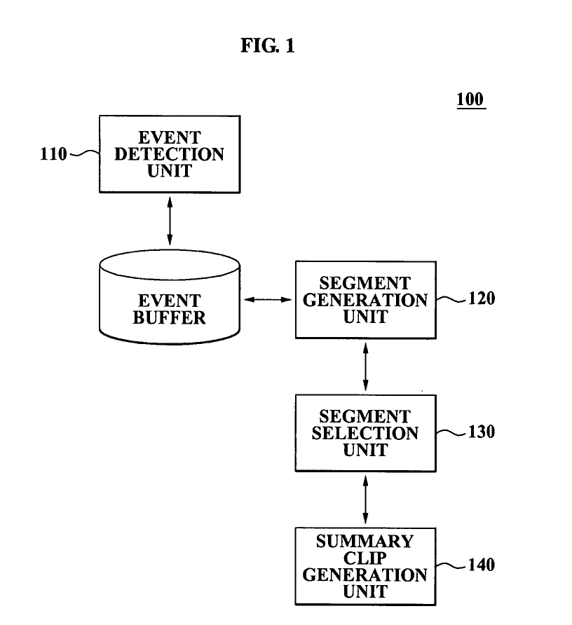

FIG. 1 is a block diagram illustrating a configuration of a summary clip generation system 100 according to an exemplary embodiment of the present invention.

Referring to FIG. 1, the summary clip generation system 100 includes an event detection unit 110, a segment generation unit 120, a segment selection unit 130, and a summary clip generation unit 140.

The event detection unit 110 detects a video event and an audio event from multimedia contents. Specifically, the video event is generated from at least any one of a scene transition part and a contents change part of the multimedia contents, and an audio event is generated according to an auditory component change.

The event detection unit 110 detects the video event by referring to shot information, corresponding to a shot extracted from a video signal of the multimedia contents. The shot information may include at least any one of shot time information and shot color information, corresponding to the shot. The shot in this specification indicates a predetermined multimedia frame section which is divided by a single camera movement when recording the multimedia, and a basic process unit to divide the multimedia contents into each scene.

Also, as an embodiment of the present invention, the video event, detected from the event detection unit 110, is generated according to application of a GT effect. The GT effect indicates a graphic effect which is intentionally inserted into a transition part of the multimedia contents. Therefore, the point where the GT effect is applied is considered to be where a contents change has occurred in the transition part of the multimedia contents. As an example, the GT effect may include at least any one of a fade effect, a dissolve effect, and a wipe effect. Generally, the fade effect exits between a frame to be faded-in and a frame to be faded-out, and a single color frame exits in a center of frames.

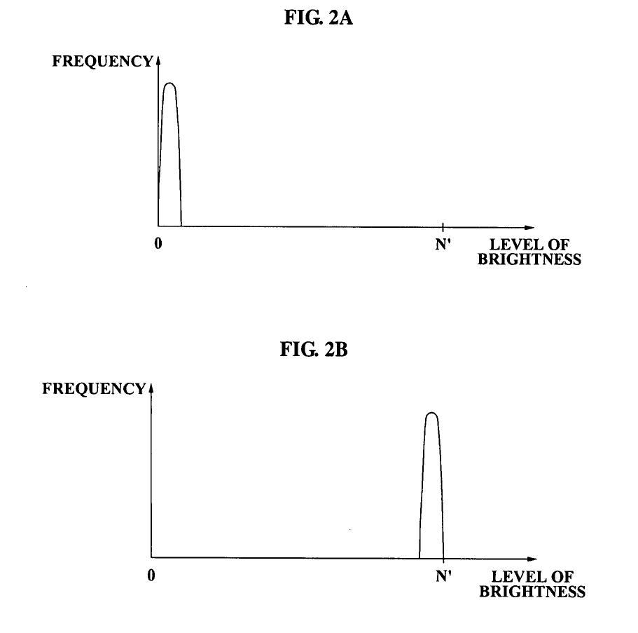

FIG. 2A and FIG. 2B are graphs illustrating an example of detecting a video event according to an exemplary embodiment of the present invention.

Referring to FIG. 2A and FIG. 2B, a horizontal axis of the graphs indicate a level of brightness, a vertical axis indicates frequency, N′ in the horizontal axis indicates a brightness value of the level of brightness. When the GT effect is the fade effect, the event detection unit 110 detects the single color frame existing between the frame to be faded-in and the frame to be faded-out using a color histogram of the multimedia contents, and determines the detected single color frame as the video event. The single color frame may be a black frame as illustrated in FIG. 2 A and a white frame as illustrated in FIG. 2 B.

Also, as another embodiment of the present invention, the event detection unit 110 calculates an average and a standard deviation of an audio feature, corresponding to each frame, using an audio feature extracted by a predetermined frame from an audio signal of the multimedia contents, and detects the audio event using the calculated average and the standard deviation of the audio feature. The audio feature may include at least any one of a Mel-frequency cepstral coefficient (MFCC), a spectral flux, a centroid, a rolloff, a Zero Crossing Rate (ZCR), an energy, and a pitch.

Specifically, the event detection unit 110 generates an audio feature value using the calculated average and the standard deviation of the audio feature, and detects the audio event, generated according to the auditory component change, by dividing the audio features using the audio feature value.

The segment generation unit 120 generates at least one segment by dividing or merging at least one shot which forms the multimedia contents, by referring to the video event.

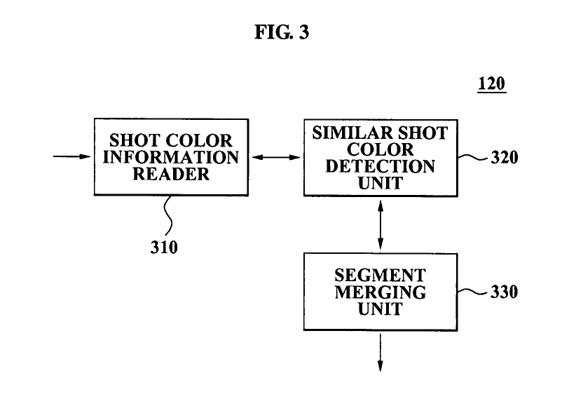

FIG. 3 a diagram illustrating an example of the segment generation unit 120 of FIG. 1.

Referring to FIG. 3, the segment generation unit 120 includes a shot color information reader 310, a similar shot color detection unit 320 and a segment merging unit 330.

The shot color information reader 310 reads shot color information which is included in a predetermined search window size, from an event buffer, the event buffer recoding the shot color information corresponding to a shot, included in the video event. As an example, the search window size may be determined by an electronic program guide (EPG).

The similar shot color detection unit 320 calculates a similarity between the read shot color information using Equation 1 below, and detects similar shot color information using the calculated similarity.

$$Sim ( {H}_{1} , {H}_{2} ) = {\sum }_{n = 1}^{N} min [ {H}_{1} ( n ) , {H}_{2} ( n ) ] \\ ( {H}_{1} ( n ) \text{:} histogram of shot color , N \text{:} level of histogram ) \qquad [ Equation 1 ]$$

The segment merging unit 330 merges the similar shot color information to generate a segment.

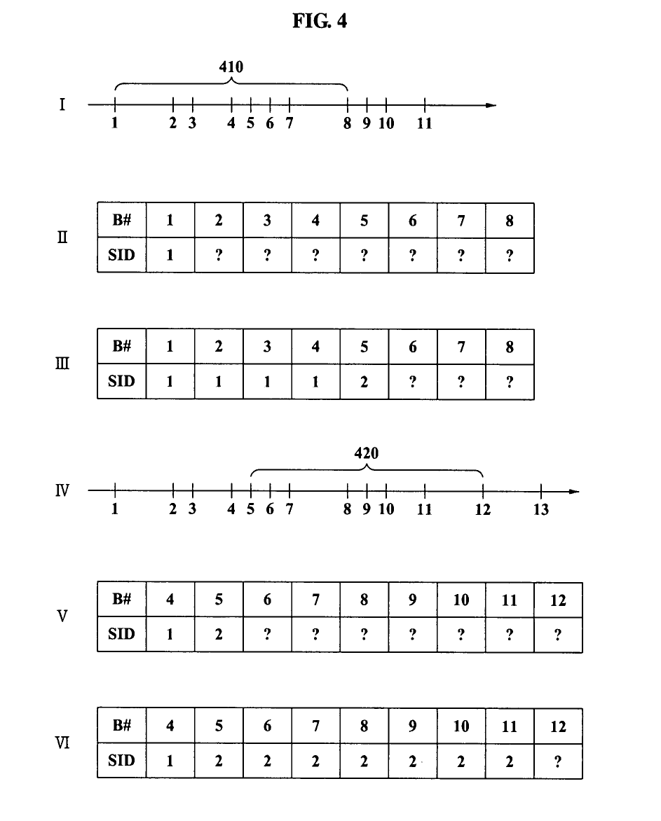

FIG. 4 parts I through VI are diagrams illustrating an example of detecting similar shot color information according to an exemplary embodiment of the present invention.

Referring to FIG. 4, part I and IV indicate at least one shot, included in the multimedia contents, is sequentially arranged. Also, “B#” of FIG. 4, parts II, III, V and VI indicate a number of event buffers, i.e. a number of shots, and SID indicates an identity (ID) of a segment corresponding to the number of the event buffer.

Initially, the segment generation unit 120 of FIG. 1 detects similar shot color information with respect to shots B# 1 through 8, corresponding to a search window size 410, from an event buffer, the event buffer recoding the shot color information corresponding to the at least one shot, included in the video event.

As illustrated in part II of FIG. 4, the segment generation unit 120 of FIG. 1 establishes an SID, corresponding to a first buffer B# 1, as “1” as shown in FIG. 4, part I, and calculates each similarity of shot color information from the first buffer B# 1 to an eighth buffer B# 8 using Equation 1. Similar shot color information is indicated when a number which is established for the SID is identical, and the segment merging unit 330 of FIG. 3 generates one segment by merging the similar shot color information corresponding to the identical number.

More specifically, the shot color information reader 310 reads shot color information included in the search window size 410, the at least one shot being included in the search window size 410, and the similar shot color detection unit 320 of FIG. 3 calculates a similarity between shot information of the first buffer B# 1 and shot information of the eighth buffer B# 8 using equation 1, and detecting similar shot color information using the calculated similarity. Subsequently, the similar shot color detection unit 320 of FIG. 3 calculates a similarity between shot color information of the first buffer B# 1 and shot color information of a seventh buffer B# 7, calculates a similarity between shot color information of the first buffer B# 1 and shot color information of a sixth buffer B# 6, and similarly continues to finally calculate similarities between shot color information of the first buffer B# 1 and shot color information of a second buffer B# 2 in descending order.

In this case, the similar shot color detection unit 320 of FIG. 3 determines whether the similarity, calculated from shot color information of the first buffer B# 1 and shot color information of the eighth buffer B# 8, is greater than a threshold, and when it is determined the determination result is not greater than the threshold, it is determined the shot color information of the first buffer B# 1 is not similar to the shot color information of the eighth buffer B# 8, subsequently the similar shot color detection unit 320 of FIG. 3 calculates the similarity between shot color information of the first buffer B# 1 and shot color information of the seventh buffer B# 7. Also, the similar shot color detection unit 320 of FIG. 3 determines whether the calculated similarity is greater than the threshold, and when it is determined the determination result is greater than the threshold as the determination result, it is determined shot color information from the first buffer B# 1 to the seventh buffer B# 7 are all similar, and corresponding SIDs from the first buffer B# 1 to the seventh buffer B# 7 may be established as “1”. Namely, the similar shot color detection unit 320 of FIG. 3 is not required to calculate a similarity between shot color information of the first buffer B# 1 and shot color information of the second buffer B# 1 through B# 6. In this case, the segment merging unit 330 of FIG. 3 generates one segment by merging a shot of the first buffer B# 1 to a shot of the seventh buffer B# 7.

As another example, when a frame where the fade effect, i.e. the GT effect, has been applied is included in a fourth buffer B# 4 as illustrated in FIG. 4, part III, the similar shot color detection unit 320 of FIG. 3 establishes an SID corresponding to the first buffer B# 1 to an SID corresponding to the fourth buffer B# 4 as “1”, and the segment merging unit 330 of FIG. 3 generates one segment by merging shots from the first buffer B# 1 to the fourth buffer B# 4. Subsequently, an SID corresponding to a fifth buffer B# 5 is established as “2” as shown in FIG. 4, part IV, the shot color information reader 310 of FIG. 3 reads shot color information corresponding to shots 420, based on the shot of the fifth buffer B# 5, as described above, the similar shot color detection unit 320 of FIG. 3 detects similar shot color information by comparing shot color information which is stored in the fifth buffer B5# with shot color information of a sixth buffer B# 6 through a twelfth buffer 12 B# 12, and the segment merging unit generates a segment by merging the detected similar shot color information.

Referring back to FIG. 1, the segment selection unit 130 selects at least one segment whose uprush degree is greater than a predetermined level among the segments by referring to the calculated uprush degree, the uprush degree is being calculated using the video event and the audio event corresponding to each of the generated segment.

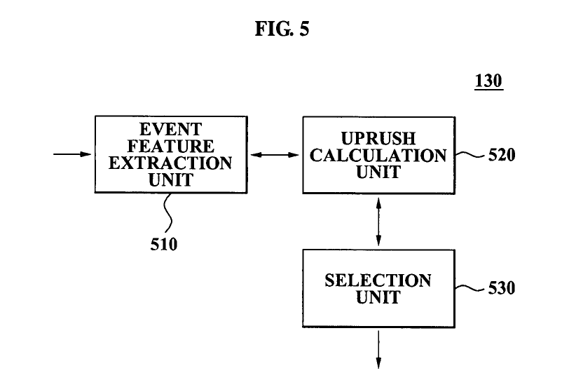

FIG. 5 is a block diagram illustrating an example of the segment selection unit 130 of FIG. 1.

Referring to FIG. 5, the segment selection unit 130 includes an event feature extraction unit 510, an uprush degree calculation unit 520, and a selection unit 530.

The event feature extraction unit 510 extracts event feature information with respect to a video event and an audio event corresponding to the segment.

As an embodiment of the present invention, the event feature information with respect to the video event corresponds to a shot change rate of the video event, and the shot change rate of the video event is calculated using Equation 2 below.

$$SCR = \frac{S}{N \#} \\ ( \begin{matrix}SCR \text{:} shot change rate , \\ S \text{:} number of shots included in segment , \\ N \# \text{:} number of frames included in segment\end{matrix} ) \qquad [ Equation 2 ]$$

As another embodiment of the present invention, the event feature information with respect to the audio event corresponds to an audio signal energy, and the audio signal energy is calculated using Equation 3 below.

$$AE = \sqrt{\frac{1}{N} {\sum }_{i = 0}^{N - 1} {S}_{n}^{2} ( i )} \\ ( \begin{matrix}AE \text{:} average energy within the segment shot , \\ Sn ( i ) \text{:} {i}^{th} sample within segment , \\ N \text{:} length of segment\end{matrix} ) \qquad [ Equation 3 ]$$

As still another embodiment of the present invention, the event feature information corresponds to music class ratio of the audio event, and the music class ratio is calculated using Equations 4 and 5 below.

$$\begin{matrix}MCR = \frac{{\sum }_{j = 1}^{J} SM [ C ( j ) , “ Music ” ]}{J} & [ Equation 4 ] \\ SM [ C ( j ) , “ Music ” ] = \{ \begin{matrix}1 , C ( j ) = “ Music ” \\ 0 , C ( j ) \neq “ Music ”\end{matrix} \\ ( \begin{matrix}MCR \text{:} music class ratio within the segment shot , \\ j \text{:} \begin{matrix}number of sequences which are composed of \\ an identical audio event included in segment\end{matrix}\end{matrix} ) & [ Equation 5 ]\end{matrix}$$

The uprush calculation unit 520 calculates the uprush degree corresponding to each of the segments using the event feature information.

The selection unit 530 selects a segment whose uprush degree is greater than a predetermined level according to the calculated uprush degree.

As an example of the selection unit 530, the selection unit 530 selects a segment whose uprush degree is greater than the predetermined level by applying a weight to at least any one of the shot change rate, the audio signal energy, and the music class ratio of the audio event. As an example, when it is determined the music class rate of the audio event of the audio event is important, the selection unit 530 selects the segment by applying the weight, e.g. 5:2:3, with respect to the shot change rate, the audio signal energy and the music class ratio of the audio event. As another example of the selection unit 530, the selection unit 530 selects the segment according to at least any one of a user's request, a type of multimedia contents, and a desired time. As an example, when the multimedia contents is an action movie, since the shot change rate, the audio signal energy, and the music class ratio of the audio event are important, selection unit 530 selects the segment by applying the weight, e.g. 4:3:3, with respect to the shot change rate, the audio signal energy, and the music class ratio of the audio event.

Referring back to FIG. 1, the summary clip generation unit 140 generates the summary clip using the selected segment.

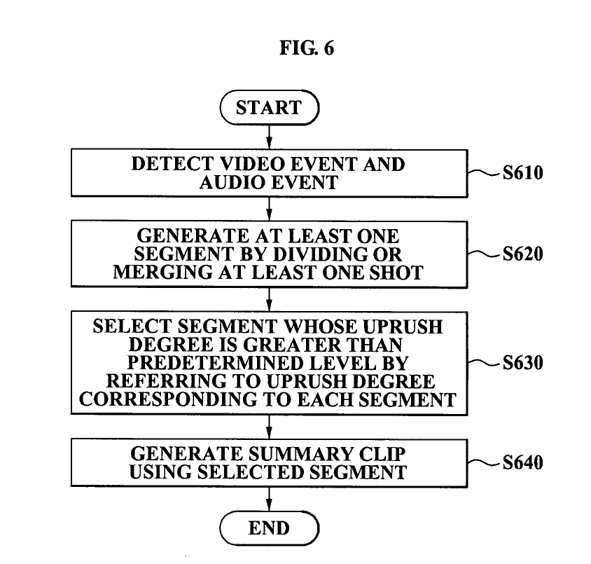

FIG. 6 is a flowchart illustrating a summary clip generation method according to an exemplary embodiment of the present invention.

Referring to FIG. 6, in operation S610, the summary clip generation method detects a video event and an audio event from multimedia contents. The video event is generated from at least any one of a scene transition part and a contents change part of the multimedia contents, and the audio event is generated according to an auditory component change.

As an example of operation S610, the video event may be detected by referring to shot information, the shot information corresponding to a shot which is extracted from a video signal of the multimedia contents. The shot information may include at least any one of shot time information and shot color information corresponding to the shot.

As an embodiment of the present invention, the video event may be generated according to application of a GT effect. The GT effect indicates a graphic effect which is intentionally inserted into a transition part of the multimedia contents. Therefore, it is considered that a contents change has occurred from the transition part of the multimedia contents, the point where the GT effect is applied. As an example, the GT effect may include at least any one of a fade effect, a dissolve effect and a wipe effect.

As another example of operation S610, an average and a standard deviation of an audio feature, corresponding to each frame, using an audio feature which is extracted from an audio signal of the multimedia contents for a predetermined frame, is calculated, and the audio event is detected using the calculated average and the standard deviation of the audio feature. As an example, the audio feature may include at least any one of a Mel-frequency cepstral coefficient (MFCC), a spectral flux, a centroid, a rolloff, a Zero Crossing Rate (ZCR), an energy, and a pitch.

In operation S620, the summary clip generation method generates at least one segment by dividing or merging at least one shot which forms the multimedia contents, by referring to the video event.

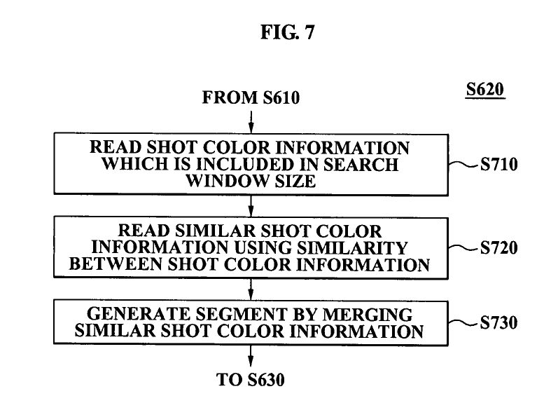

FIG. 7 is a flowchart illustrating an example of the segment generation method of FIG. 6.

Referring to FIG. 7, in operation S710, the summary clip generation method reads shot color information which is included in a predetermined search window size, from an event buffer, the event buffer recoding the shot color information corresponding to the shot, included in the video event.

In operation S720, the summary clip generation method calculates a similarity between the read shot color information using Equation 1 below, and detects similar shot color information using the calculated similarity.

$$Sim ( {H}_{1} , {H}_{2} ) = {\sum }_{n = 1}^{N} min [ {H}_{1} ( n ) , {H}_{2} ( n ) ] \\ ( {H}_{1} ( n ) \text{:} histogram of shot color , N \text{:} level of histogram ) \qquad [ Equation 1 ]$$

In operation S730, the summary clip generation method generates a segment by merging the similar shot color information.

Referring back to FIG. 6, in operation S630, the summary clip generation method selects at least one segment whose uprush degree is greater than a predetermined level among the segments by referring to a calculated uprush degree, the uprush degree being calculated using the video event and the audio event corresponding to each of the generated segment.

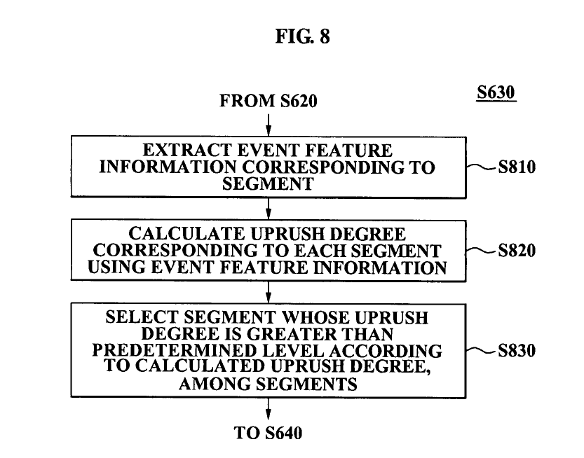

FIG. 8 is a flowchart illustrating an example of the segment selection method of FIG. 6.

Referring to FIG. 8, in operation S810, the summary clip generation method extracts event feature information with respect to the video event and the audio event corresponding to the segment.

As an embodiment of the present invention, the event feature information with respect to the video event corresponds to a shot change rate of the video event, and the shot change rate of the video event is calculated using Equation 2 below.

$$SCR = \frac{S}{N \#} \\ ( \begin{matrix}SCR \text{:} shot change rate , \\ S \text{:} number of shots included in segment , \\ N \# \text{:} number of frames included in segment\end{matrix} ) \qquad [ Equation 2 ]$$

As another embodiment of the present invention, the event feature information with respect to the audio event corresponds to an audio signal energy, and the audio signal energy is calculated using Equation 3 below.

$$AE = \sqrt{\frac{1}{N} {\sum }_{i = 0}^{N - 1} {S}_{n}^{2} ( i )} \\ ( \begin{matrix}AE \text{:} average energy within the segment shot , \\ Sn ( i ) \text{:} {i}^{th} sample within segment , \\ N \text{:} length of segment\end{matrix} ) \qquad [ Equation 3 ]$$

As still another embodiment of the present invention, the event feature information corresponds to music class ratio of the audio event, and the music class ratio is calculated by Equations 4 and 5 below.

$$\begin{matrix}MCR = \frac{{\sum }_{j = 1}^{J} SM [ C ( j ) , “ Music ” ]}{J} & [ Equation 4 ] \\ SM [ C ( j ) , “ Music ” ] = \{ \begin{matrix}1 , C ( j ) = “ Music ” \\ 0 , C ( j ) \neq “ Music ”\end{matrix} \\ ( \begin{matrix}MCR \text{:} music class ratio within the segment shot , \\ j \text{:} \begin{matrix}number of sequences which are composed of \\ an identical audio event included in segment\end{matrix}\end{matrix} ) & [ Equation 5 ]\end{matrix}$$

Also, in operation S820, the summary clip generation method calculates the uprush degree corresponding to each of the segments using the event feature information.

Also, in operation S830, the summary clip generation method selects a segment whose uprush degree is greater than a predetermined level according to the calculated uprush degree.

As an example of the operation S830, the summary clip generation method selects a segment whose uprush degree is greater than the predetermined level by applying a weight to at least any one of the shot change rate, the audio signal energy, and the music class ratio of the audio event. As another example of the selection unit 530, the selection unit 530 selects the segment according to at least any one of a user's request, a type of multimedia contents, and a desired time.

Referring back to FIG. 6, in operation S640, the summary clip generation method generates the summary clip using the selected segment.

Hereinafter, a detailed description will be omitted since the summary clip generation method according to the present invention is similar to the method described above, and the aforementioned embodiments from FIG. 1 through FIG. 5 may be applied to this embodiment.

The summary clip generation method according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, there is provided a summary clip generation system and a summary clip generation method which can generate a summary clip of multimedia contents using uprush degree of at least one segment which is calculated by dividing or merging a shot forming the multimedia contents.

Also, according to the present invention, there is provided a summary clip generation method which can satisfy a user's need since a summary clip is generated by selecting a segment according to a user's requirements or a type of multimedia contents.

Also, according to the present invention, there is provided a summary clip generation method which can accurately extract a highlight portion since a summary clip of multimedia contents is generated using a shot change rate, an audio signal energy, and a music class ratio.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A summary clip generation system comprising:
an event detection unit detecting a video event and an audio event from multimedia contents;
a segment generation unit generating at least one segment by dividing or merging at least one shot which forms the multimedia contents, by referring to the video event; and
a segment selection unit selecting a segment whose uprush degree is greater than a predetermined level, from the at least one segment by referring to the uprush degree which is calculated using the video event and the audio event, corresponding to each of the generated segments.

2. The system of claim 1, wherein the video event is generated from at least any one of a scene transition part and a contents change part of the multimedia contents, and the audio event is generated according to an auditory component change.

3. The system of claim 1, wherein the event detection unit detects the video event by referring to shot information, the shot information corresponding to a shot which is extracted from a video signal of the multimedia contents.

4. The system of claim 3, wherein the shot information comprises at least any one of time information and color information corresponding to the shot.

5. The system of claim 1, wherein the video event, detected from the event detection unit, is generated according to application of a GT effect.

6. The system of claim 1, wherein the event detection unit calculates an average and a standard deviation of an audio feature, for each frame, using an audio feature which is extracted from an audio signal of the multimedia contents for a predetermined frame, and detects the audio event using the calculated average and the standard deviation of the audio feature.

7. The system of claim 1, wherein the segment generation unit comprises:
a shot color information reader reading shot color information which is included in a predetermined search window size, from an event buffer, the event buffer recoding the shot color information corresponding to the shot, included in the video event;
a similar shot color detection unit calculating a similarity between the read shot color information using Equation 1 below, and detecting similar shot color information using the calculated similarity; and
a segment merging unit merging the similar shot color information to generate a segment.
$$Sim ( {H}_{1} , {H}_{2} ) = {\sum }_{n = 1}^{N} min [ {H}_{1} ( n ) , {H}_{2} ( n ) ] \\ ( {H}_{1} ( n ) \text{:} histogram of shot color , N \text{:} level of histogram ) \qquad [ Equation 1 ]$$

8. The system of claim 1, wherein the segment selection unit comprises:
an event feature extraction unit extracting event feature information with respect to the video event and the audio event corresponding to the segment;
an uprush degree calculation unit calculating the uprush degree, corresponding to each of the segments, using the event feature information; and
a selection unit selecting the segment whose uprush degree is greater than the predetermined level.

9. The system of claim 8, wherein the event feature information with respect to the video event corresponds to a shot change rate of the video event, and the shot change rate of the video event is calculated using Equation 2 below.
$$SCR = \frac{S}{N \#} \\ ( \begin{matrix}SCR \text{:} shot change rate , \\ S \text{:} number of shots included in segment , \\ N \# \text{:} number of frames included in segment\end{matrix} ) \qquad [ Equation 2 ]$$

10. The system of claim 8, wherein the event feature information with respect to the audio event corresponds to the audio signal energy, and the audio signal energy is calculated using Equation 3 below.
$$AE = \sqrt{\frac{1}{N} {\sum }_{i = 0}^{N - 1} {S}_{n}^{2} ( i )} \\ ( \begin{matrix}AE \text{:} average energy within the segment shot , \\ Sn ( i ) \text{:} {i}^{th} sample within segment , \\ N \text{:} length of segment\end{matrix} ) \qquad [ Equation 3 ]$$

11. The system of claim 8, wherein the event feature information with respect to the audio event corresponds to a music class ratio within the segment shot of the audio event, the rate of music is calculated using Equations 4 and 5 below.
$$\begin{matrix}MCR = \frac{{\sum }_{j = 1}^{J} SM [ C ( j ) , “ Music ” ]}{J} & [ Equation 4 ] \\ SM [ C ( j ) , “ Music ” ] = \{ \begin{matrix}1 , C ( j ) = “ Music ” \\ 0 , C ( j ) \neq “ Music ”\end{matrix} \\ ( \begin{matrix}MCR \text{:} music class ratio within the segment shot , \\ j \text{:} \begin{matrix}number of sequences which are composed of \\ an identical audio event included in segment\end{matrix}\end{matrix} ) & [ Equation 5 ]\end{matrix}$$

12. The system of claim 8, wherein the selection unit selects the segment whose uprush degree is greater than the predetermined level by applying a weight to at least any one of the shot change rate of the video event, the audio signal energy and the music class ratio of the audio event.

13. A summary clip generation method, the method comprising:
detecting a video event and an audio event from multimedia contents;
generating at least one segment by dividing or merging at least one shot which forms the multimedia contents, by referring to the video event;
selecting a segment whose uprush degree is greater than a predetermined level from the at least one segment by referring to the uprush degree which is calculated using the video event and the audio event, corresponding to each of the generated segments; and
generating a summary clip by the selected segment.

14. The method of claim 13, wherein the video event is generated from at least any one of a scene transition part and a contents change part of the multimedia contents, and the audio event is generated according to an auditory component change.

15. The method of claim 13, wherein the detecting of the video event detects the video event by referring to shot information, corresponding to the shot which is extracted from a video signal of the moving picture.

16. The method of claim 15, wherein the shot information comprises at least any one of time information and color information corresponding to the shot.

17. The method of claim 13, wherein the video event, detected from the event detection unit, is generated according to application of a GT effect.

18. The method of claim 13, wherein the detecting of the event detects, calculates an average and a standard deviation of an audio feature, corresponding to each frame, using an audio feature which is extracted from an audio signal of the multimedia contents for a predetermined frame, and detects the audio event using the calculated average and the standard deviation of the audio feature.

19. The method of claim 13, wherein the generating of the segment comprises:
reading shot color information which is included in a predetermined search window size, from an event buffer, the event buffer recording the shot color information corresponding to the shot, included in the video event;
calculating a similarity between the read shot color information using Equation 1 below, and detecting similar shot color information using the calculated similarity; and
merging the similar shot color information to generate a segment.
$$Sim ( {H}_{1} , {H}_{2} ) = {\sum }_{n = 1}^{N} min [ {H}_{1} ( n ) , {H}_{2} ( n ) ] \\ ( {H}_{1} ( n ) \text{:} histogram of shot color , N \text{:} level of histogram ) \qquad [ Equation 1 ]$$

20. The method of claim 13, wherein the selecting of the segment further comprises:
extracting event feature information with respect to the video event and the audio event which corresponds to the segments;
calculating the uprush degree, corresponding to each of the segments, using the event feature information; and
selecting the segment whose uprush degree is greater than the predetermined level.

21. The method of claim 20, wherein the event feature information with respect to the video event corresponds to a shot change rate of the video event, and the shot change rate of the video event is calculated using Equation 2 below.
$$SCR = \frac{S}{N \#} \\ ( \begin{matrix}SCR \text{:} shot change rate , \\ S \text{:} number of shots included in segment , \\ N \# \text{:} number of frames included in segment\end{matrix} ) \qquad [ Equation 2 ]$$

22. The method of claim 20, wherein the event feature information with respect to the audio event corresponds to an audio signal energy, and the audio signal energy is calculated using Equation 3 below.
$$AE = \sqrt{\frac{1}{N} {\sum }_{i = 0}^{N - 1} {S}_{n}^{2} ( i )} \\ ( \begin{matrix}AE \text{:} average energy within the segment shot , \\ Sn ( i ) \text{:} {i}^{th} sample within segment , \\ N \text{:} length of segment\end{matrix} ) \qquad [ Equation 3 ]$$

23. The method of claim 20, wherein the event feature information with respect to the audio event corresponds to a music compression rate of the audio event, the rate of music is calculated using Equations 4 and 5 below.
$$\begin{matrix}MCR = \frac{{\sum }_{j = 1}^{J} SM [ C ( j ) , “ Music ” ]}{J} & [ Equation 4 ] \\ SM [ C ( j ) , “ Music ” ] = \{ \begin{matrix}1 , C ( j ) = “ Music ” \\ 0 , C ( j ) \neq “ Music ”\end{matrix} \\ ( \begin{matrix}MCR \text{:} music class ratio within the segment shot , \\ j \text{:} \begin{matrix}number of sequences which are composed of \\ an identical audio event included in segment\end{matrix}\end{matrix} ) & [ Equation 5 ]\end{matrix}$$

24. The method of claim 20, wherein the selecting the segment selects the segment whose uprush degree is greater than the predetermined level by applying a weight to at least any one of the shot change rate of the video event, the audio signal energy and the music compression rate of the audio event.

25. A computer-readable storage medium storing a program for implementing a summary clip generation method, the method comprising:
detecting a video event and an audio event from multimedia contents;
generating at least one segment by dividing or merging at least one shot which forms the multimedia contents, by referring to the video event;
selecting a segment whose uprush degree is greater than a predetermined level from the at least one segment by referring to the uprush degree which is calculated using the video event and the audio event, corresponding to each of the generated segments; and
generating a summary clip using the selected segment.
